(19) United States
(12) Patent Application Publication
(10) Pub. No.: US 2006/0169007 A1
(43) Pub. Date: Aug. 3, 2006

(54) Resettable lock

(75) Inventor: John D. Fiegener, Marblehead, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Staples The Office Superstore, LLC, Framingham, MA (US)

(21) Appl. No.: 11/115,710

(22) Filed: Apr. 27, 2005

Related U.S. Application Data
(60) Provisional application No. 60/649,305, filed on Feb. 2, 2005.

(51) Int. Cl. E05B 37/02

(52) U.S. Cl. 70/25; 70/312

(57) ABSTRACT

The invention is generally directed to a lock having a combination that may be reset by a user. The combination of the lock may be reset when a portion of the lock body is moved relative to another portion of the lock body, thereby moving the lock body from a lock position to a reset position. The lock may include a locking member, such as a shackle. One end of the locking member may be connected to a fixed portion of the lock body while the other end of the locking member may be connectable to a movable portion of the lock body. The lock may also include an unlocking member, such as a plurality of dials, that when aligned in an unlocking position, allow the lock to be opened. The unlocking position of the unlocking member may be reset when the lock body is in a reset position.

### RELATED APPLICATIONS

This application claims the benefit under 35 U.S.C. § 119(e) to U.S. Provisional Patent Application Ser. No. 60/649,305, entitled “Resettable Lock,” filed on Feb. 2, 2005, which is incorporated herein by reference in its entirety.

### FIELD OF THE INVENTION

The invention relates to locks, more particularly to a combination lock having a resettable combination and a method of resetting a combination lock.

### BACKGROUND OF THE INVENTION

Numerous lock constructions have been developed and are widely employed by individuals to prevent unauthorized persons from gaining access to any area which has been closed and locked. Although many locks are constructed to be opened by a key, numerous combination locks have been developed which are opened by knowledge of a particular combination.

One particular type of combination lock that has become very popular due to its ease and convenience of use is a combination lock which employs a plurality of rotatable independent dials. On each dial are a plurality of indicia, usually numerals or letters, which may be chosen as a part of the combination for releasing the lock. The dial may be rotated into a variety of positions, however a ‘clicking’ mechanism may guide the user into discrete positions. Typically, each discrete position will correspond to one of the indicia. Typically, the combination lock has one mode or position in which the user is able to set or reset the desired combination sequence. Although locks of this general nature have been available for several decades, these prior art combination lock constructions suffer from common deficiencies which have not been successfully overcome.

Although many manufacturers have attempted to solve the problems associated with rotatable dial or combination locks, these prior art constructions have been unable to produce a lock construction which inhibits the lock from locking when the lock is in its combination set or reset position. As a result, the combination can be accidentally or inadvertently changed without the user becoming aware of the new combination.

Additionally, the resetting feature of most combination locks is an additional mechanical piece, such as a button or a key. The addition of such a feature may not only increase manufacturing costs, but provides an additional piece that could be damaged or lost, possibly rendering the lock worthless.

Another common problem with combination locks is that when the user is resetting the desired combination sequence, the ‘clicking’ feature of the lock, which guides the dials into the discrete positions, cannot be employed.

### SUMMARY OF THE INVENTION

The present invention presents a novel lock that may be transformed into a reset position by moving a portion of the lock body. When the lock is in this reset position, the lock may not be accidentally or inadvertently locked. In addition, the lock may have an unlocking member that when the combination or unlocking position is being reset or repositioned, enables the user to feel a ‘clicking’ or detent that guides the user into resetting the lock in one of the discrete positions.

According to one aspect, a combination lock is provided. The lock may include a lock body including a movable portion. A locking member may be connectable to the movable portion. When the movable portion is moved to a reset position, a combination of the lock is adapted to be reset.

According to another aspect, a lock is provided. The lock may include a locking member having a first end and a second end and being movable between an open position and a closed position. The lock may also include a lock body having a first lock body portion and a second lock body portion. The first end of the locking member may be connected to the first lock body portion and the second end of the locking member may be connectable to the second lock body portion. The lock body may be convertible between a lock position, wherein the first lock body portion is in a first configuration relative to the second lock body portion, and a reset position, wherein the first lock body portion is in a second configuration relative to the second lock body portion. The first configuration may be different from the second configuration. The lock may further include an unlocking member connected to the lock body. The unlocking member may be movable between an unlocking position and at least one locking position. The unlocking position of the unlocking member may be adapted to be repositioned when the lock body is in the reset position.

According to another aspect, a combination lock is provided. The combination lock may include a locking member having a first end and a second end and being movable between an open position and a closed position. The combination lock may further include a lock body having a first lock body portion and a second lock body portion. The first end of the locking member may be connected to the first lock body portion and the second end of the locking member may be connectable to the second lock body portion. The combination lock may also include an unlocking member connected to the lock body. The unlocking member may be movable between an unlocking position, at least one locking position and a repositioning position. When the unlocking member is in the repositioning position, the unlocking position of the locking member may be repositioned. The unlocking member may include a dial, a flange, and a shim. When the unlocking member is in the unlocking position or in the at least one locking position, the shim may directly engage the flange and the flange may directly engage the dial. When the unlocking member is in the repositioning position, the shim may directly engage the dial.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, similar features are represented by like reference numerals. For purposes of clarity, not every component is labeled in every drawing. In the drawings:

FIG. 1A is a perspective view of an illustrative embodiment of a lock in a lock position;

FIG. 1B is a perspective view of the lock of FIG. 1A in a reset position;

FIG. 2 is a perspective view of an illustrative embodiment of a locking member of a lock;

FIG. 3 is a fragmented, perspective view of an illustrative embodiment of a lock having some components removed to better illustrate the interrelationship of certain components;

FIG. 3A is an enlarged, perspective view of some of the unlocking member components encircled by line 3A of FIG. 3;

FIG. 3B is a cross-sectional view of an illustrative embodiment of a portion of a lock body and a ram, taken along line 3B-3B of FIG. 3;

FIG. 4 is a fragmented, perspective view of an illustrative embodiment of a lock having some components removed to better illustrate the interrelationship of certain components;

FIG. 5 is an enlarged, cross-sectional view of an illustrative embodiment of a portion of a lock body, a pusher and a retaining ring, taken along line 5-5 of FIG. 1B;

FIG. 6A is a fragmented, side view of an illustrative embodiment of a lock in a lock position, the lock having some components removed to better illustrate the interrelationship of certain components

FIG. 6B is a fragmented, side view of the lock of FIG. 6A in a reset position, the lock having some components removed to better illustrate the interrelationship of certain components

FIG. 7 is a perspective view of an interior of a portion of a lock body and a pusher, when the lock body is in a lock position; and

FIG. 8 is a fragmented, perspective view of an illustrative embodiment of a portion of lock with a portion of a lock body shown in semi-transparency.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Aspects of the invention are described below with reference to illustrative embodiments. It should be understood that reference to these illustrative embodiments is not made to limit aspects of the invention in any way. Instead, illustrative embodiments are used to aid in the description and understanding of various aspects of the invention. Therefore, the following description is intended to be illustrative, not limiting.

A lock is provided where the combination of the lock may be reset by moving at least a portion of the lock body relative to another portion of the lock body. One embodiment of the present invention is generally directed to a combination lock having a combination that may be rest. The combination of the lock may be reset when a portion of the lock body is moved relative to another portion of the lock body. The combination lock may include a lock body, locking member, such as a shackle or a cable, and an unlocking member, such as dials containing indicia thereon.

The shackle may have two ends, one of which is connected to the lock body and the other of which is connectable to the lock body. When both ends of the shackle are connected to the lock body, the shackle is in a closed position and the lock is locked. When one end of the shackle is disconnected from the lock body, the shackle is in an open position and the lock is unlocked. To disconnect one end of the shackle from the lock body and unlock the lock, the dials must be aligned in the combination of the lock. When the indicia are aligned to display the combination, the dials are in an unlocking position. When the indicia do not display the combination, the dials are in a locking position and the lock may not be unlocked.

The unlocking position of the dials (e.g., the combination of the lock) may be reset by a user by moving the lock body from a lock position into a reset position. This conversion may be accomplished by moving a moving portion of the lock body relative to a fixed portion of the body. In one embodiment, this conversion may be accomplished by rotating the movable portion relative to the fixed portion.

In one embodiment, the unlocking member may include at least one dial, at least one flange and at least one shim. The dial is constructed and arranged so that a user can control the positioning of the dial. The flange is constructed and arranged so that when the lock is being locked or unlocked, the dial controls the positioning of the flange and when the lock is being reset, the dial does not control the positioning of the flange. The shim is constructed and arranged so that when the lock is being locked or unlocked, the shim clicks the flange into position and when the lock is being reset, the shim clicks the dial into position.

The aspects of the present invention may be employed singularly or in any suitable combination as the present invention is not limited in this respect. Also, any or all of the these aspects may be employed in a lock, such as a combination lock; however, the present invention is not limited in this respect, as aspects of the invention may be used in cable locks (e.g., where the locking member is a cable), button locks (e.g., where the unlocking member includes buttons), keypad locks (e.g., where the unlocking member includes a keypad) or with any other locks, including other locks employing any electronic or mechanical elements. Various aspects and embodiments of the invention will now be described in more detail with respect to the accompanying figures. The invention is not, however, limited to the aspects and embodiments shown. In some of the figures that follow, specific numerical values are used to describe the numbers of elements and/or performance/size parameters. It should be appreciated that such values are not necessarily limiting, but rather, are merely exemplary only.

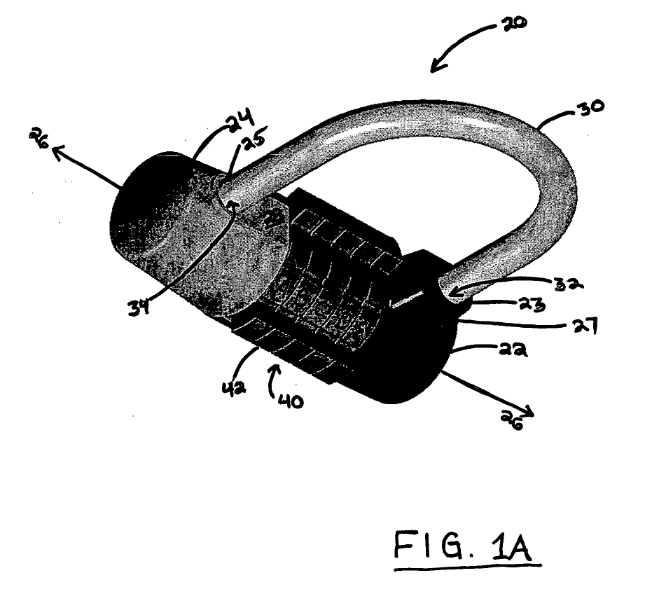

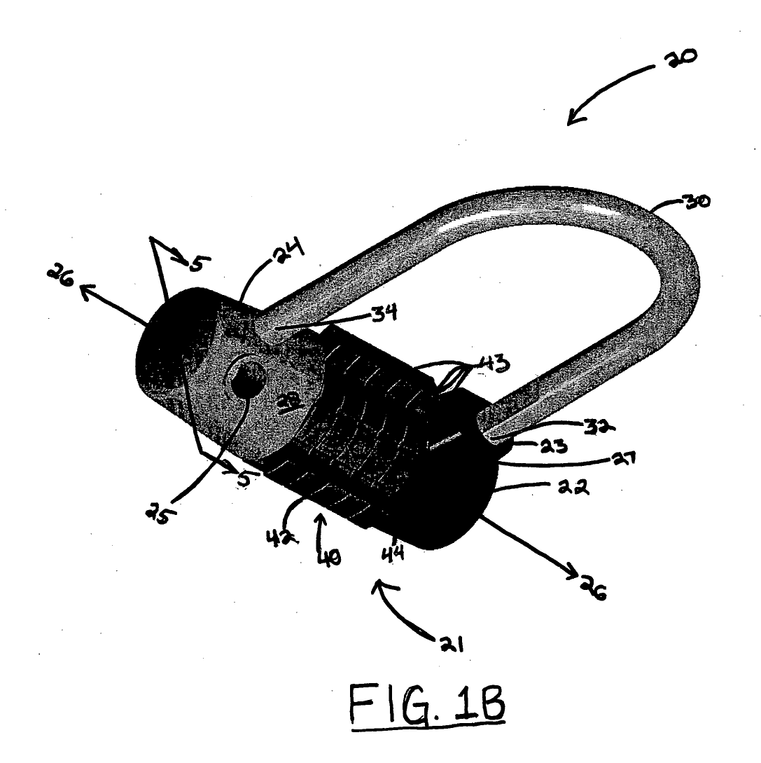

As can be seen in the embodiments shown in FIGS. 1A and 1B, lock 20 may include a lock body 21 having a first lock body portion 22 and a second lock body portion 24, a locking member, such as a shackle 30, and an unlocking member 40, which may include dials 42. Lock body 21, which may also be described as, for example, a lock housing or casing, may be selectively and repeatedly convertible between a lock position, as is shown in the embodiment depicted in FIG. 1A, and a reset position, as is shown in the embodiment depicted in FIG. 1B. The locking member may be repeatedly convertible between an open position, as is shown in the embodiment depicted in FIG. 1B, and a closed position, as is shown in the embodiment depicted in FIG. 1A.

Lock body 21 may have a generally cylindrical shape and may define a lock axis 26. Lock axis 26 may be the axis about which second lock body portion 24 rotates when converting lock body 21 between the lock position and the reset position. Lock axis 26 may also run generally perpendicular to direction in which locking member 30 moves when traveling between the open position and the closed position.

First lock body portion 22 may have a generally cylindrical shape and include a first inlet 23 into which a portion of the locking member may be inserted. First inlet 23 may be located in a raised portion 27 of first lock body portion 22, as shown in FIGS. 1A & 1B, may be flush with the major surface of first lock body portion 22 (not shown) or may be located in an indented portion of the first lock body portion (not shown), as the present invention is not intended to be limiting in this manner.

Second lock body portion 24 may also have a generally cylindrical shape and include a second inlet 25 into which another portion of the locking member may be inserted. Although second inlet 25 is shown relatively flush with a major surface 28 of second lock body portion 24, the second inlet may be located in a raised or indented portion of the second lock body portion. It should be appreciated that the lock body and the lock body portions may have any shape, such as cubical, pyramidal, spherical or any other shape, and the lock body portions need not have similar shapes to one another, as the present invention is not limited in this respect.

In one embodiment, second lock body portion 24 is the moving portion of the lock body and first lock body portion 22 is the fixed portion of the lock body.

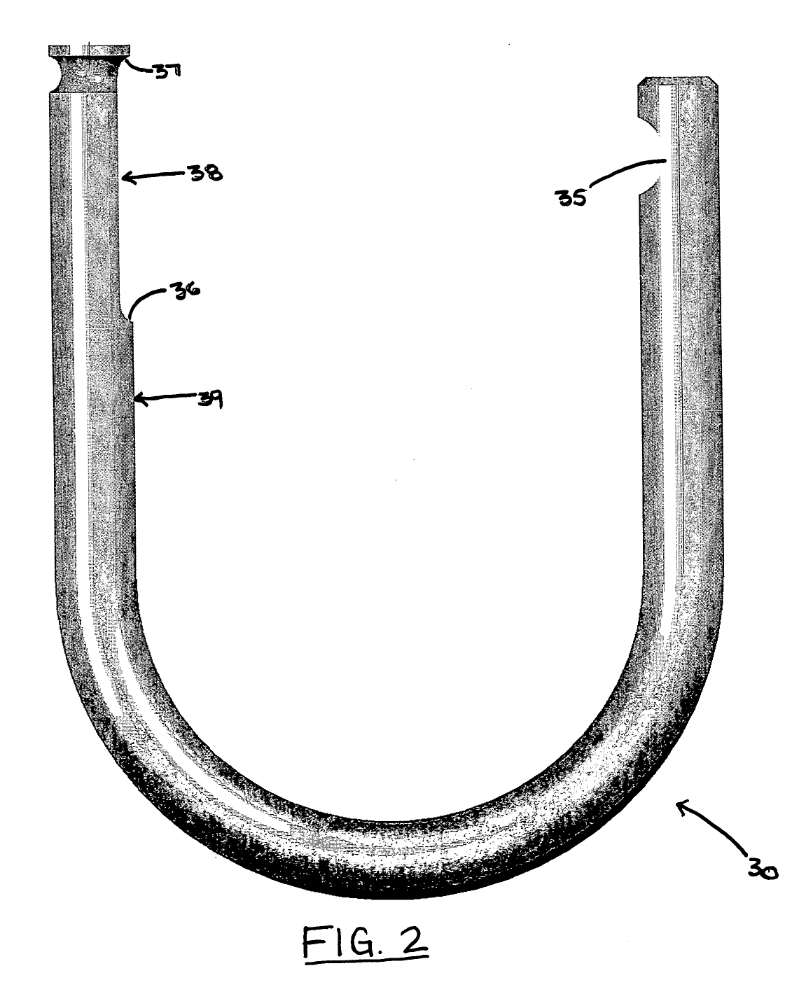

As shown in FIGS. 1A and 1B, the locking member may be a shackle 30 having a U or J shape. As alluded to above, shackle 30, which may also be described as, for example, a hook, hasp or fastener, may have a first portion, such as a first end 32, which may be connected to first lock body portion 22, and a second portion, such as a second end 34, which may be connectable to second lock body portion 24. First end 32 may contain a first lip 36 and a second lip 37. First lip 36 may be positioned to abut the outside of first inlet 23 when shackle 30 is in the closed position; second lip 37 may be positioned to abut the inside of first inlet 23 when shackle 30 is in the open position. Although in FIG. 2, lips 36, 37 may be created by carving out a portion 38 of shackle 30 between the two lips, it should be appreciated that the lips may protrude out of major surface 39 the locking member (not shown). Second end 34 may contain a divot 35 into which the head of the ram will be inserted, as will be explained below.

When the locking member is in the closed position, as is shown in the embodiment depicted in FIG. 1A, first end 32 is connected to first lock body portion 22 via first inlet 23 and second end 34 is connected to second lock body portion 24 via second inlet 25. When the locking member is in the open position, first end 32 is connected to first lock body portion 22 via first inlet 23 and second end 34 is not connected to second lock body portion 24. First end 32 of the locking member may be inhibited from disconnecting completely from first lock body portion 22 by second lip 37 abutting against the inside of first inlet 23.

In order to move locking member 30 from the closed position to the open position, unlocking member 40 must be in the correct unlocking position. As shown in the embodiments of FIGS. 1A and 1B, unlocking member 40 may include dials 42, which may also be described as, for example, tumblers, rings, discs, wheels, sleeves, or knobs. Dials 42 may be donut-like rings that rotate independently about lock axis 26. Each dial 42 may have indicia 43 located thereon in discrete locations, such that when dial 42 is rotated, indicia 43 rotate with dial 42 and, resultantly, indicia 43 change positions. Indicia 43 may be letters, numbers, ciphers, symbols, colors, patterns, textures, any combination thereof, or any marking or indicator that is distinguishable from another marking or indicator, as the present invention is not intended to be limiting in this respect. To facilitate rotating and positioning of dials 42, dials 42 may include a raised portion 44 or another form of grip or texture, as the present invention is not limited in this respect. Although in the embodiments depicted in many of the accompanying figures, there are five dials, it should be appreciated that there may be one, two, three, four, five, ten or any number of dials, as the present invention is not limited in this respect.

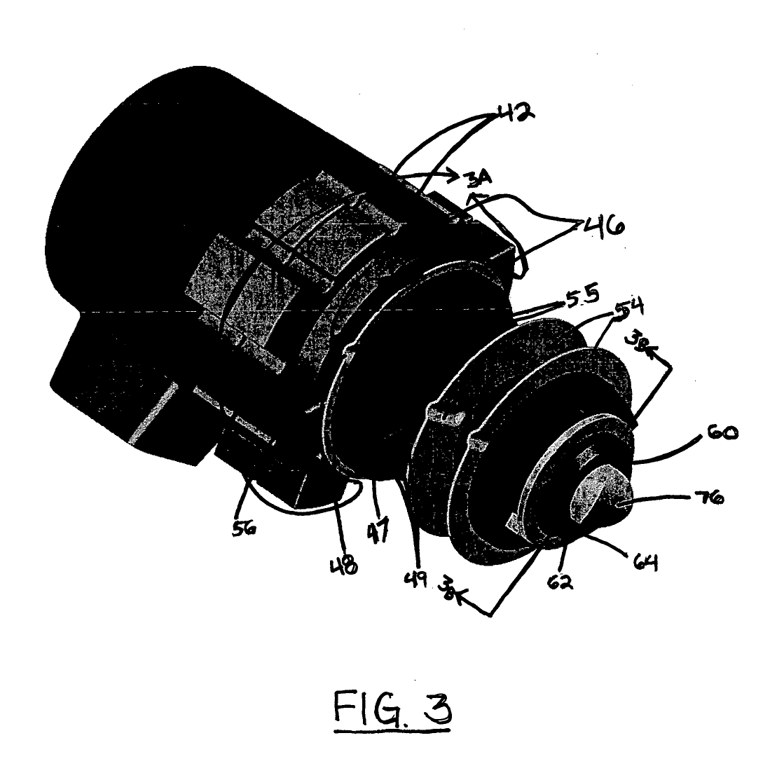

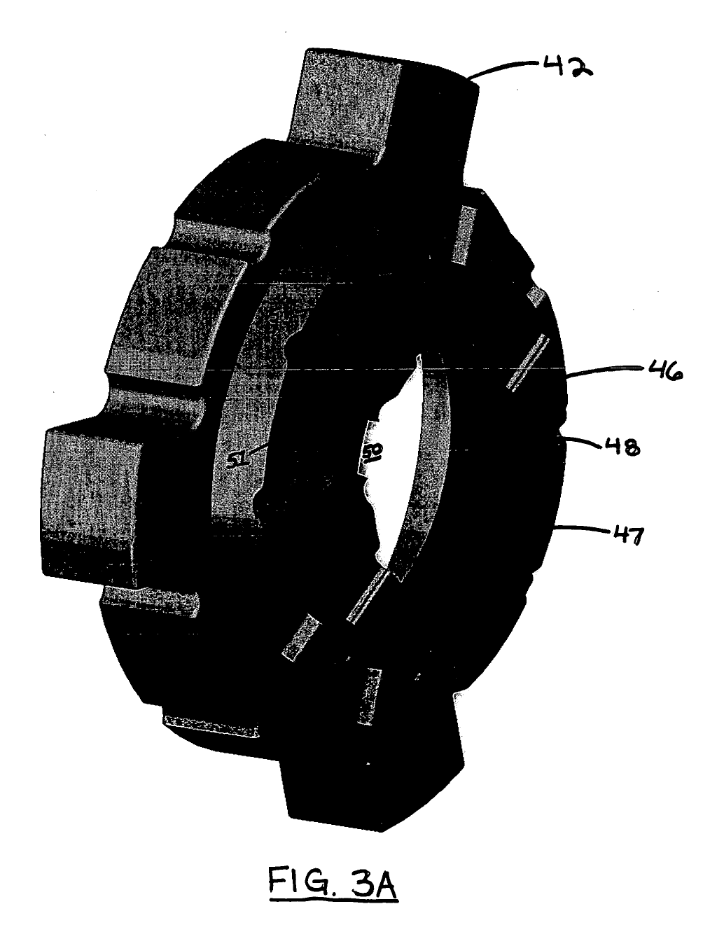

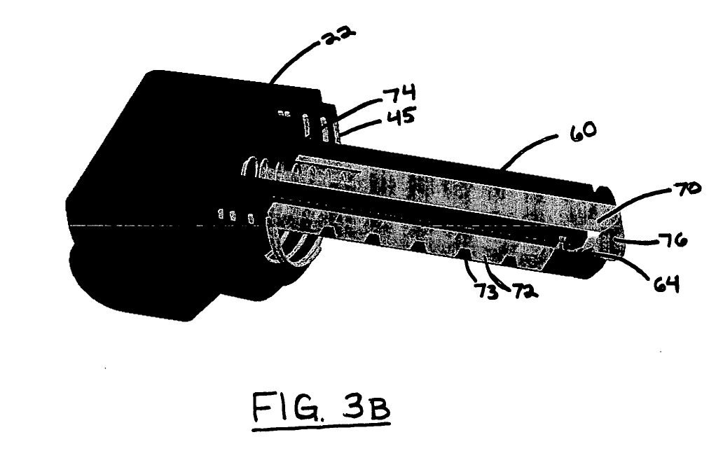

As is shown in the embodiment represented in FIG. 3, unlocking member 40 may also include flanges 46, which may also be described as, for example, cups, rolls, discs, dials, sleeves, clutches, rings or actuating members. Flanges 46 may be donut-like rings that rotate about lock axis 26 independently from one another. Although in the embodiments depicted in many of the accompanying figures, there are five flanges, it should be appreciated that there may be one, two, three, four, five, ten or any number of flanges, as the present invention is not limited in this respect. Additionally, although in the embodiments depicted there are the same number of dials as there are flanges, it should be appreciated that there may be additional flanges or dials as the present invention is not intended to be limiting in this respect.

When the lock is in the lock position, as shown in FIGS. 1A and 3, each flange 46 may be connected to a dial 42. As is shown in enlarged unlocking member in FIG. 3A, dial 42 may have a dial engaging feature, such as holes 51, that engages a flange engaging feature, such as projections 49, such that when dial 42 is turned, flange 46 turns therewith. Spring 45 may bias flanges 46 towards engagement with dials 42.

Each flange 46 may have a first portion 47 having a smaller circumference than a second portion 48 having a larger circumference. The larger size of second portion 48 may inhibit spring 45 from biasing flange 46 towards moving completely through dial 42, as second portion 48, in combination with the flange engaging feature, will obstructed by the inside of dial 42. The smaller size of first portion 47, however, allows it to pass completely through dial 42 to engage a shim 54. Additionally, the inside of second portion 48 of flange 46 may have a larger diameter than the inside of first portion 47 of flange 46, thereby creating a cavity 59 in which teeth 72 may be allowed to rotate freely, as will be explained further below.

Because the shim, which may also be described as, for example, a spacer, snap means or detenter, is constructed to assist in positioning the dial and the flange, it is desirable for at least one of flange 46 and dial 42 to engage shim 54. Shim 54 may be a disc that is stamped with a shim mating feature, such as detents 56. The shim mating feature may be constructed to engage with a flange mating feature, such as notches 55, which may be located on first portion 47 of flange 46. Detents 56 and notches 55 may guide flange 46 to ‘click’ into a discrete number of positions, allowing the user to know when flange 46 is in one of the discrete number of positions. Without detents 56 and notches 55, it may be very difficult and time consuming for a user to try to manually maneuver flange 46 (via manipulating dial 42) into one of a nearly infinite number of positions. It should be appreciated, however, that this is a feature of some embodiments of the present invention and is not intended to be a required feature of all embodiments. The shim mating feature may also be constructed to engage with a dial mating feature, such as notches 57 (the purpose of which will be explained below with respect to repositioning the unlocking member).

To inhibit shim 54 from rotating about lock axis 26 with flange 46 or dial 42 when flange 46 and/or dial 42 are rotated, shim 54 may have a tongue-like projection 58 adapted to fit into a groove 62 in an intermediate lock body portion 60. Although groove 62 may inhibit shim 54 from turning about lock axis 26, groove 62 may allow tongue 58 to slide along groove 62, thereby enabling shim 54 to move along lock axis 26. It should be appreciated that the above description is one illustrative method of inhibiting rotation of an element about an axis while allowing movement along the axis and may be accomplished by a variety of constructions, as the present invention is not intended to be limiting in this manner.

It should also be appreciated that the above description is one illustrative embodiment of an unlocking member and the function of the unlocking member (e.g. controlling the locking and unlocking of the lock) may be performed by a variety of structures, such as buttons, switches, keys, any other control, or any combination thereof, as the present invention is not intended to be limiting in this respect.

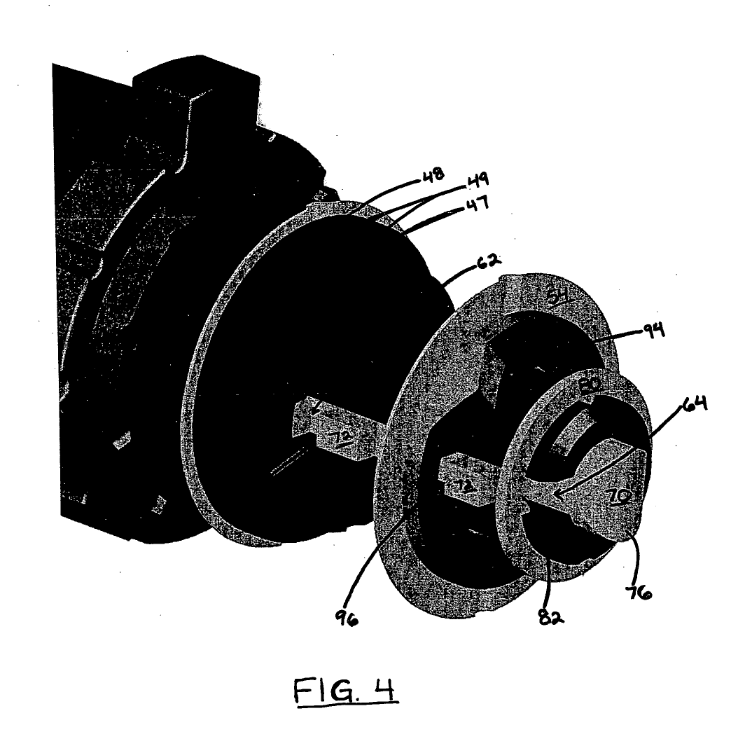

As can be seen in the embodiments in FIGS. 3 and 4, intermediate lock body portion 60 may be a tube and may be formed integrally with first lock body portion 22, such that when second lock body portion 24 moves relative to first lock body portion 22, second lock body portion 24 may also move relative to intermediate lock body portion 60. Intermediate lock body portion 60 may have at least one groove 62 running along one side thereof and an opening 64 along another side thereof. Opening 64 may be adapted to accommodate teeth 72 of a ram 70.

As shown in the embodiments depicted in FIGS. 3B and 4, ram 70, which may also be described as, for example, a dead bolt, lock shaft, stop rod, locking bolt or toothed rod, may be a cylinder centered about lock axis 26. Teeth 72 may project radially along one side of ram 70 and through opening 64 in intermediate lock body portion 60. Ram 70 may be adapted to slide along the inside of intermediate lock body portion 60, while teeth 72 are free to move along opening 64. Teeth 72 may extend beyond opening 64 and abut flanges 46.

As shown in the embodiment depicted in FIG. 4, shim 54 and first portion 47 of flange 46 may have alcoves 52, 50 adapted to accommodate teeth 72. As will be explained further below, when first portion 47 of flange 46 is positioned in a space 73 between teeth 72 and teeth 72 are located in cavity 59 underneath second portion 48 of flange 46, flange 46 may rotate relatively unrestrained about lock axis 26. When teeth 72 are in an alcove 50 of a flange 46, however, that flange 46 may be inhibited from rotating about lock axis 26.

In one embodiment, the number of teeth 72 may correspond to the number of dials 42 and flanges 46 and/or alcoves 50. In an alternative embodiment, some of the dials may be ‘dummy dials’ in that they need not be correctly positioned for the lock to open. Therefore, there may be fewer teeth than dials 42 and flanges 46, as the present invention is not intended to be limiting in this respect.

As can be seen in FIG. 3B, ram 70 may further have a spring 74 at one end that biases ram 70 towards second lock body portion 24 and away from first lock body portion 22. In one embodiment, when spring 74, which may also be described as, for example, an elastic or biasing member, is extended and ram 70 is biased towards second lock body portion 24, flanges 46 may rotate unrestrained by teeth 72, as teeth 72 will be positioned in cavity 59 underneath second portion 48 of flange 46. Ram 70 may not be able to be moved against the spring bias, however, until alcoves 50 of flanges 46 are positioned about spaces 73, so that teeth 72 may be slid into alcoves 50, as will be explained further below.

Ram head 76 is located at the non-spring end of ram 70. Ram head 76 may be constructed to engage divot 35 in second end 34 of shackle 30. Spring 74 biases ram head 76 to remain engaged with divot 35, thereby inhibiting shackle 30 from being removed from second lock body portion 24. The above-described functions of the ram, teeth and ram head may be accomplished by a variety of constructions and arrangements and the present invention is not intended to be limited in this respect.

Because ram 70 may be spring biased to inhibit ram 70 from coming too far or completely out of intermediate lock body portion 60, an instrument for retaining the ram in intermediate lock body portion 60 may be utilized. In one embodiment, a retaining ring 80 may be used to inhibit ram 70 from exiting intermediate lock body portion 60. Retaining ring 80 may be fixedly attached to intermediate lock body portion 60 and may contain a lip 82. Lip 82 may fit into and block a portion of opening 64, thereby inhibiting teeth 72 from coming out of intermediate lock body portion 60. Further, to maintain a connection between second lock body portion 24 and the other parts of the lock, second lock body portion 24 may have a ring-receiving cavity 84 into which retaining ring 80 may fit. These functions may be performed by a variety of structures, such as a stop that is attached to the intermediate lock body portion 70 (not shown) located in opening 64 and/or in ring-receiving cavity 84, as the present invention is not intended to be limiting in this respect.

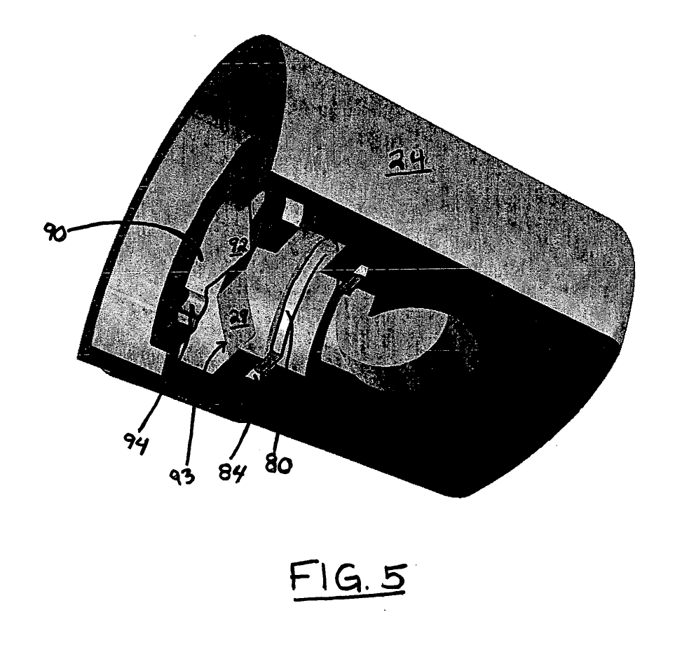

In one embodiment, as is depicted in FIGS. 4 and 5, a pusher 90 may be positioned to be pushed by second lock body portion 24 when second lock body portion 24 is moved relative to first lock body portion 22. Pusher 90, which may also be described as, for example, an actuator, push ring or urging member, may have at least one tongue 94 adapted to fit into groove 62, to inhibit pusher 90 from rotating about lock axis 26. Although, as described above with respect to the shim, this function may be accomplished by a variety of constructions and arrangements as the present invention is not intended to be limited in this respect.

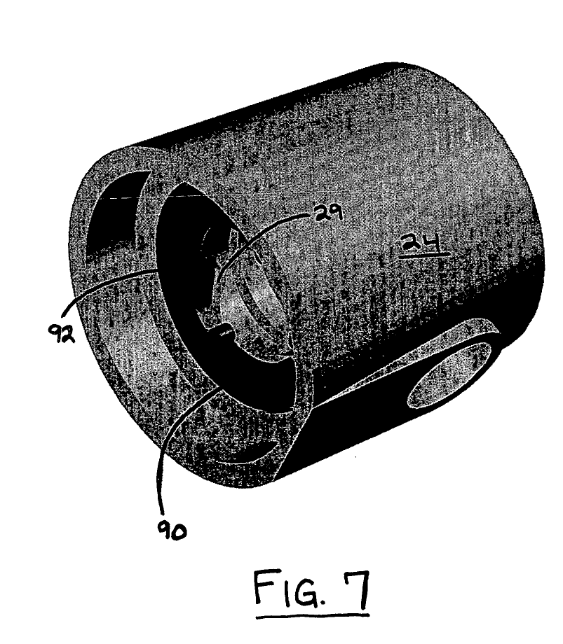

Pusher 90 may also have a ramp 92 adapted to engage with a ramp 29 of second lock body portion 24. As is shown in the embodiment depicted in FIG. 7, when the lock is in the lock position, ramp 92 is flush with ramp 29. When the lock is moved from the lock position (shown in FIG. 7) to the reset position (shown in FIG. 5), ramp 29 of second lock body portion 24 and ramp 92 of pusher 90 may abut against one another, causing pusher 90 to move father away from second lock body portion 24. Again, this function may be accomplished by a variety of structures and arrangements as the present invention is not intended to be limiting in this respect.

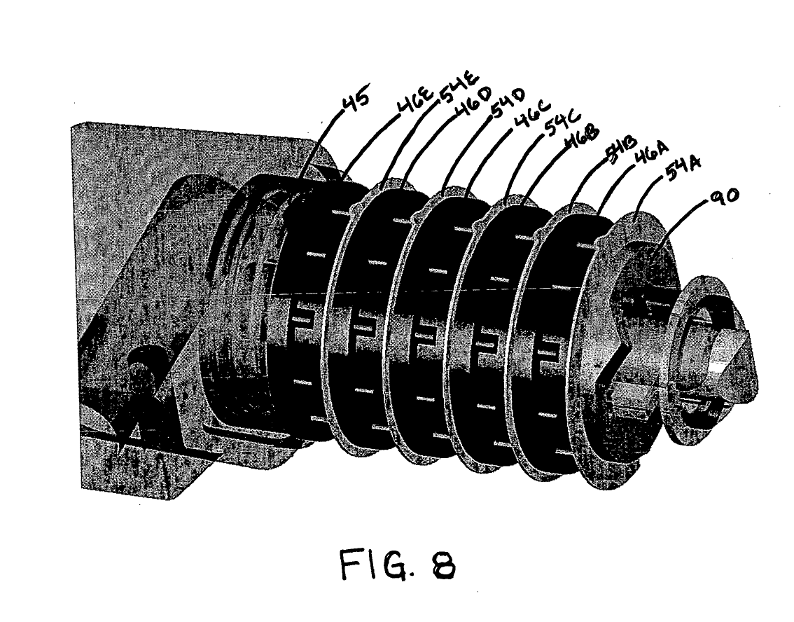

Pusher 90 may abut at least a portion of the unlocking member and transmit the pushing force onto the portion of the unlocking member, causing the portion of the unlocking member to move father away from second lock body portion 24. As can been seen in the embodiment of FIG. 8, pusher 90 abuts shim 54A, such that when pusher 90 is pushed away from second lock body portion 24, shim 54A is pushed along intermediate lock body portion 60, pushing some of the other pieces of the unlocking member (e.g., flanges 46A, 46B, 46C, 46D, and 46E and other shims 54B, 54C, 54D, and 54E), against the bias of spring 45.

It should be appreciated that a variety of elements may cause at least a portion of the unlocking member to shift away from second lock body portion 24 when second lock body portion 24 is moved relative to first lock body portion 22. For example, the shim nearest to the second lock body portion may have a surface against which second lock body portion 24 may push, as the present invention is not intended to be limiting in this respect.

As can be seen in the embodiment of FIG. 4, pusher 90 may also have an alcove 96 for teeth 72 of ram 70.

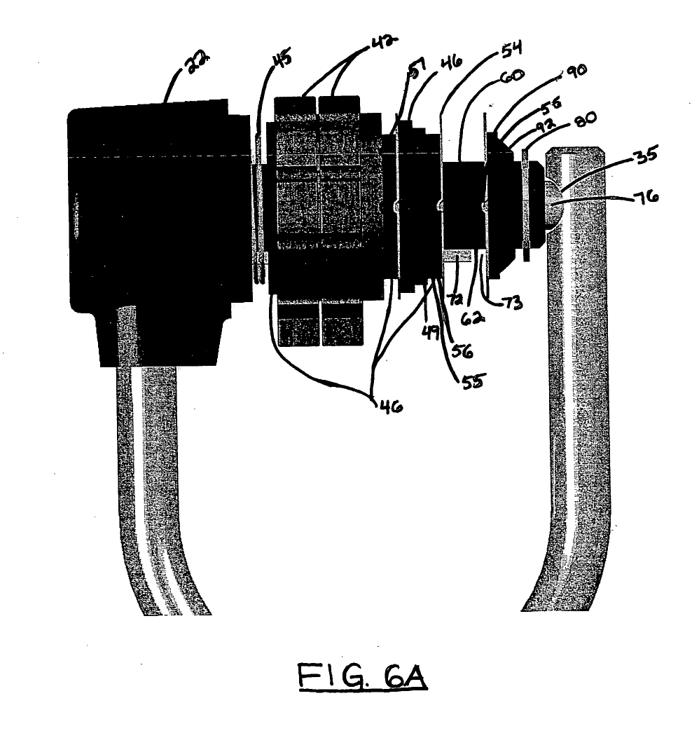

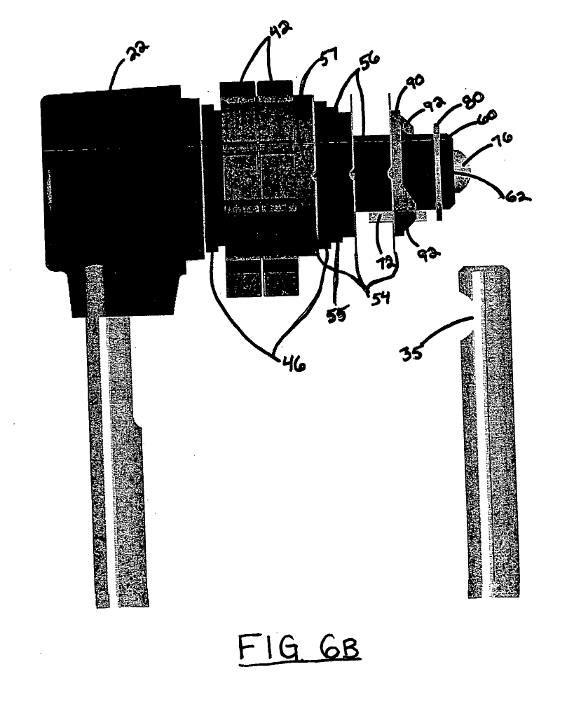

The mechanics of how the lock works will now be explained. As described briefly above, the lock body may be convertible between a lock position, as shown in the embodiment of FIG. 1A, and a reset position, as shown in the embodiment of FIG. 1B. The locking member or shackle 30 may be movable between a closed position, as shown in the embodiment depicted in FIG. 1A, and an open position, as shown in the embodiment depicted in FIG. 1B. Additionally, unlocking member 40 may be movable between an unlocking position (not shown), at least one locking position, as shown in the embodiment of FIG. 6A, and a repositioning position, as shown in the embodiment of FIG. 6B. When the lock body is in the lock position, the locking member may be in either the open or the closed position and the unlocking member may be in either the unlocking or a locking position. When the lock body is in the reset position, the locking member may be in the open position and the unlocking member may be in the repositioning position.

As is shown in the embodiments depicted in FIGS. 1A, 3, 6A and 7, the lock is in a lock position, the locking member is in a closed position and the unlocking member is in a locking position. In these embodiments: first lock body portion 22 is in a first configuration relative to second lock body portion 24; first and second inlets 23, 25 of lock body 21 may be aligned about lock axis 26; first lip 36 of shackle 30 may be abutting the outside of first inlet 23; spring 45 may be extended, thereby pushing flange 46 into dial 42 so that the flange engaging feature may be engaging the dial engaging feature (e.g., projections 49 of flanges 46 may be in holes 51 of dials 42); the shim mating feature may be engaging the flange mating feature (e.g., detents 56 of shims 54 may be in notches 55 of flanges 46); spring 74 of ram 70 may be extended, such that ram 70 may be biased towards second lock body portion 24; ram head 76 may be inserted into divot 35 of shackle 30, so that shackle 30 may not be disconnected from lock body 21; teeth 72 may be located in cavities 59 underneath second portions 48 of flanges 46 and first portions 47 of flanges 46 may be located in spaces 73 in-between teeth 72, so that flanges 46 may rotate uninhibited by teeth 72; and ramp 92 of pusher 90 may be flush with ramp 29 of second lock body portion 24.

To move the unlocking member from a locking position to the unlocking position, a user may turn dials 42 until all of the dials are aligned in the unlocking combination (i.e., indicia 43e aligned in the unlocking combination). As the user turns each dial 42, flange 46 will turn with that dial 42, because the flange engaging feature may be engaged with the dial engaging feature (e.g., projections 49 of flange 46 may be in holes 51 of dial 42, as can be seen in FIG. 3A). As flange 46 turns, detents 56 of shim 54 may periodically engage notches 55 of the flange, thereby guiding dial 42 and flange 46 into one of the discrete number of positions. When dials 42 have been guided in to an unlocking position, such that each alcove 50 of each flange 46 is aligned over a space 73, teeth 72 can move into alcoves 50, thereby allowing ram 70 to move against the bias of spring 74 and towards first lock body portion 22. Once ram 70 is able to move towards first lock body portion 22, ram head 76 may disengage with divot 35 of shackle 30 and second end 34 of shackle 30 may be pulled out of second lock body portion 24.

To enable a user to choose a different unlocking combination of indicia, the lock body may be moved from the lock position to a reset position, allowing the relationship between the flange and the dial to be repositioned. The second lock body portion may be moved relative to the first lock body portion, thereby moving the second lock body portion into a second configuration relative to the first lock body portion. In one embodiment, the second lock body portion may be rotated about lock axis 26. For example, second lock body portion 24 may be rotated so that second inlet 25 is 45° offset from first inlet 23, as is shown in the embodiment in FIG. 1B. It should be appreciated that the second lock body portion may be rotated less than 45° or more than 45° as the present invention is not intended to be limited in this respect. Additionally, the second lock body portion need not be rotated about the lock axis, but may be moved in another way, such as moving along the lock axis, displacement from the lock axis or any other movement relative to another portion of the lock body as the present invention is not intended to be limited in this respect.

It should be appreciated that in the embodiment, such as is shown in FIG. 1B, wherein second inlet 25 is moved out of alignment with second end 34 of the locking member, the lock may not be accidentally locked. That is, second end 34 of shackle 30 may not be inserted into second inlet 25 because the two pieces are out of alignment. If the locking member were moved towards second lock body portion 24, it would contact the surface of the lock body and not be aligned to enter second inlet 25.

As shown in the embodiments depicted in FIGS. 1B, 4, 5 and 6B, second lock body portion 24 may be rotated about lock axis 26 relative to first lock body portion 22 and/or relative to intermediate lock body portion 60. As second lock body portion 24 is rotated, ramp 29 of second lock body portion 24 moves against ramp 92 of pusher 90. Because retaining ring 80 holds second lock body portion 24 fixed with respect to intermediate lock body portion 60 and pusher 90 cannot rotate with second lock body portion 24 due to tongues 94 being in grooves 62, pusher 90 is pushed along intermediate lock body portion 60. As can be seen in the embodiment depicted in FIG. 8, as pusher 90 is moved, it pushes against shim 54A, which pushes against flange 46A, which pushes against shim 54B, which pushes against flange 46B, which pushes against shim 54C, which pushes against flange 46C, which pushes against shim 54D, which pushes against flange 46D, which pushes against shim 54E, which pushes against flange 46E, which pushes against the bias of spring 45. As long as second lock body portion 24 remains in the reset position, the shims and flanges may remain pushed away from second lock body portion 24 in a repositioning position.

When shims 54 and flanges 46 are pushed, dials 42 disengage from flanges 46 and dials 42 remain in the same position relative to first lock body portion 22 and/or intermediate lock body portion 60. In one embodiment and as is shown in the embodiment depicted in FIG. 1B, dial 42 nearest to first lock body portion 22 abuts first lock body portion 22, such that dials 42 may not move any closer to first lock body portion 22. As flanges 46 are pushed, projections 49 of flanges 46 may extricate themselves out of holes 51 of dials 42, thereby disengaging flange 46 from dial 42. In addition, as flanges 46 are pushed towards first lock body portion 22, alcoves 50 are pushed onto teeth 72. As discussed above, when alcoves 50 are on top of teeth 72, flanges 46 may not rotate. As such, flanges 46 are fixed in their unlocking alignment, while dials 42 are able to be repositioned. Therefore, a user may reposition dials 42 into a new unlocking combination without worrying that flanges 46 are accidentally rotating with dials 42.

As shims 54 are pushed towards first lock body portion 22, detents 56 of shims 54 may engage with notches 57 of dials 42. Hence, when the user repositions dials 42, dials 42 will be ‘clicked’ or guided into one of the discrete positions and the user will not accidentally reposition dials 42 in an unlocking position that is in-between desired discrete positions.

Once the user has chosen a new unlocking combination (i.e., dials 42 have been repositioned with respect to flanges 46), the second lock body portion may be moved from the second configuration back into the first configuration, thereby converting the lock body from the reset position into the lock position. In one embodiment, as second lock body portion 24 is rotated about lock axis 26 so that first and second inlets 23, 25 are aligned, ramp 29 of second lock body portion 24 may be realigned with ramp 92 of pusher 90. As soon as ramp 92 may move with the spring bias (e.g., into opening 93 in front of ramp 29), spring 45, which has been compressed and has been exerting pressure against flanges 46, shims 54 and pusher 90, may push flanges 46, shims 54 and pusher 90 away from first lock body portion 22, thereby pushing ramp 92 into opening 93 in front of ramp 29 (as can be seen in the embodiment depicted in FIG. 5). As flanges 46 and shims 54 are pushed, the flange engaging features (e.g., projections 49) reengage the dial engaging features (e.g., holes 51), the dial mating feature (e.g., notches 57) disengages the shim mating feature (e.g., detents 56), and second portions 48 of flanges 46 move over teeth 72, such that teeth 72 are in cavities 59 under second portions 48 and alcoves 50, 52 are aligned with spaces 73.

It should be appreciated that any materials, such as metals, plastics, rubbers, woods, foams, or any other material, may be used to make any of the components of the lock. Further, some components may be made from one material while other components may be made from another material or one component may be made from more than one material, as the present invention is not intended to be limiting in this respect.

It should be appreciated that a variety of features employed in the art of locks may be used in combination with or to modify the above-described features and embodiments.

The foregoing written specification is to be considered to be sufficient to enable one skilled in the art to practice the invention. While the best mode for carrying out the invention has been described in detail, those skilled in the art to which this invention relates will recognize various alternative embodiments including those mentioned above as defined by the following claims. The examples disclosed herein are not to be construed as limiting of the invention as they are intended merely as illustrative of particular embodiments of the invention as enabled herein. Therefore, systems and methods that are functionally equivalent to those described herein are within the spirit and scope of the claims appended hereto. Indeed, various modifications of the invention in addition to those shown and described herein will become apparent to those skilled in the art from the foregoing description and fall within the scope of the appended claims.

What is claimed is:

1. A combination lock comprising:
a lock body including a movable lock body portion, a locking member being connectable to the movable lock body portion, the lock body defining a lock axis;
wherein when the movable lock body portion is rotated about the lock axis to a reset position, a combination of the lock is adapted to be reset.

2. The combination lock of claim 1, wherein the lock body further includes a fixed lock body portion being connected to the locking member, wherein when the movable lock body portion is rotated relative to the fixed lock body portion, the combination of the lock is adapted to be reset.

3. The combination lock of claim 1, wherein when the movable lock body portion is in the reset position, the movable lock body portion is adapted not to be connected to the locking member.

4. A lock comprising:
a locking member;
a lock body having a first lock body portion and a second lock body portion, a first end of the locking member being connected to the first lock body portion, a second end of the locking member being connectable to the second lock body portion, the lock body defining a lock axis, the lock body being convertible from a lock position to a reset position by rotating the second lock body portion about the lock axis relative to the first lock body portion; and
an unlocking member connected to the lock body, the unlocking member being movable between an unlocking position and at least one locking position;
wherein the unlocking position of the unlocking member is adapted to be repositioned when the lock body is in the reset position.

5. The lock of claim 4, wherein the locking member includes a shackle and the first end of the shackle is movably disposed within the first lock body portion and the second end of the shackle is insertable into the second lock body portion.

6. The lock of claim 4, wherein the lock body includes a first inlet on the first lock body portion and a second inlet on the second lock body portion, the first end of the locking member being inserted into the first inlet and the second end of the locking member being insertable into the second inlet, and wherein when the lock body is in the lock position, the first and second inlet are aligned about the lock axis and when the lock body is in the reset position, the second inlet is rotated about the lock axis relative to the first inlet.

7. The lock of claim 6, wherein when in the reset position, the second inlet is rotated approximately 45 degrees about the lock axis from the first inlet.

8. The lock of claim 4, wherein the unlocking member includes at least one flange and at least one dial having at least two indicia, the at least one flange detachably engaging the at least one dial.

9. The lock of claim 8, wherein the unlocking member further includes at least one shim, wherein when the lock body is in the lock position, the at least one shim directly engages the at least one flange and the at least one flange directly engages the at least one dial, and wherein when the lock body is in the reset position, the at least one shim directly engages the at least one dial.

10. The lock of claim 8, wherein when the lock body is in the lock position, the at least one shim assists in aligning the at least one flange, and wherein when the lock body is in the reset position, the at least one shim assists in aligning the at least one dial.

11. The lock of claim 4, wherein when the lock body is in the reset position, the second end of the locking member is inhibited from being inserted into the second lock body portion.

12. The lock of claim 4, further comprising a pusher, the second lock body portion being adapted to move relative to the pusher as the lock body is moved from the lock position to the reset position.

13. A combination lock comprising:
a locking member;
a lock body having a first lock body portion and a second lock body portion, a first end of the locking member being connected to the first lock body portion, a second end of the locking member being connectable to the second lock body portion; and
an unlocking member connected to the lock body, the unlocking member being movable between an unlocking position, at least one locking position and a repositioning position, wherein when the unlocking member is in the repositioning position, the unlocking position of the locking member may be repositioned, the unlocking member including a dial, a flange, and a shim, the shim including a shim mating feature and the dial including a dial mating feature;
wherein when the unlocking member is in the unlocking position or in the at least one locking position, the shim mating feature directly engages the flange to guide the flange into at least one of a discrete number of flange positions and the flange directly engages the dial, and when the unlocking member is in the repositioning position, the shim mating feature directly engages the dial to guide the dial into at least one of a discrete number of dial positions.

14. The combination lock of claim 13, wherein the dial has at least one dial mating feature and the flange has at least one flange mating feature, wherein when the unlocking member is in the unlocking position or in the at least one locking position, the at least one shim mating feature matingly engages the at least one flange mating feature, and wherein when the unlocking member is in the repositioning position, the at least one shim mating feature matingly engages the at least one dial mating feature.

15. The combination lock of claim 14, wherein the at least one shim mating feature is a detent and the at least one flange mating feature and the at least one dial mating feature are notches.

16. The combination lock of claim 14, wherein the dial has at least one dial engaging feature and the flange has at least one flange engaging feature, and wherein when the unlocking member is in the unlocking position or in the at least one locking position, the at least one flange engaging feature engages the at least one dial engaging feature.

17. The combination lock of claim 16, wherein the at least one dial engaging feature is not the same feature as the at least one dial mating feature and the at least one flange engaging feature is not the same feature as the at least one flange mating feature.

18. (canceled)

19. The combination lock of claim 13, further comprising a ram adapted to control a connection between the second end of the locking member and the second lock body portion, wherein when the second end of the locking member is connected to the second lock body portion and when the unlocking member is in the at least one locking position, the flange inhibits the ram from permitting the second end of the locking member from disconnecting with the second lock body portion, and wherein when the second end of the locking member is connected to the second lock body portion and when the unlocking member is in the unlocking position, the flange allows the ram to permit the second end of the locking member to disconnect with the second lock body portion.

20. The combination lock of claim 19, wherein when the unlocking member is in the repositioning position, the ram inhibits the flange from moving, and wherein when the unlocking member is in the at least one locking position, the ram does not prevent the flange from moving.
